(19) United States
(12) Patent Application Publication
(10) Pub. No.: US 2004/0050103 A1
(43) Pub. Date: Mar. 18, 2004

(54) Molding method of microlens array and molding apparatus of the same

(75) Inventor: Junichi Ishizuka, Saitama-city (JP)

Correspondence Address: JORDAN AND HAMBURG LLP, 122 EAST 42ND STREET, SUITE 4000, NEW YORK, NY, 10168, US

(73) Assignee: Fuji Photo Optical Co., Ltd., Saitama City (JP)

(21) Appl. No.: 10/619,103

(22) Filed: Jul. 14, 2003

(30) Foreign Application Priority Data
Aug. 21, 2002 (JP) 2002-240950

(51) Int. Cl. C03B 11/00

(52) U.S. Cl. 65/32.1; 65/157; 65/102; 65/305

(57) ABSTRACT

The present invention relates to a molding method of a microlens array with an enhanced transfer performance and a molding apparatus of the same. The invention addresses a method for molding a microlens array by heating and compressing a glass element between oppositely placed first and second cores, wherein a depression or projection part is formed for transferring and molding a plurality of concave lens elements on the compression molding surface of at least one of the cores. The glass element is set between each compression molding surface of the first and second cores, and is then compressed between them while providing restriction means for preventing the glass element from escaping in the direction perpendicular to the compression direction of the glass element, thereby compression molding the glass element with the restriction means and between the compression molding surfaces of the first and second cores.

### BACKGROUND OF THE INVENTION

1. Field of the Invention

This invention relates to a molding method of a microlens array whereby lens elements are molded by heating and compressing glass elements and a molding apparatus of the same.

2. Description of the Related Art

Microlens arrays are mainly used for optical fiber communications, and those of which having a lens element diameter of about 250 μm and a lens spacing of 250 μm are generally used. Those microlens arrays are fabricated by a compression molding. There is a known method and apparatus for molding such microlens arrays as shown in FIG. 1 and FIG. 2 (Japanese Patent Laid-Open No. 2001-48554). The method comprises oppositely placing a upper die 100 and a lower die 101, providing a center nest 102 (depression part) in the lower die 101, forming a plurality of microlens cavities 103 on both sides of the center nest 102, setting a glass element 200 at the center nest 102, and closing the upper and lower dies 100, 101 to heat and compress the glass element 200. When the glass element 200 is compressed, it flows into the cavities 103 as shown in FIG. 2, thus molding lens elements in the center nest 102 and the cavities 103.

In the above described prior art example, the glass element 200 is pressed by closing the upper and lower dies 100, 101 after heating the upper and lower dies 100, 101, and the pressed glass element 200 flows in radially outward directions. Thus, when the glass element flows into the cavities 103, the air in the cavities 103 is discharged and the lens elements are formed in a transferring manner. In this process, although the transfer performance was good at the center nest 102 and the cavities 103 in its vicinity, the transfer performance tended to decline as the lens location moves away from the center nest, thus resulting in worst lens transfer performances at the outermost cavities 103.

The object of the invention was to improve the transfer performance of the lens and, to achieve the object, arrangement was made such that a microlens array is press molded with its periphery being restricted. There is also a known method for press molding a single lens with its outer periphery being restricted as described in Japanese Patent Laid-Open No. 2000-1322. However, this method only applies to the molding of a single lens, and the optical performance of the single lens is determined by all of the combined transfer performances of the central area and the outer peripheral area. That is, the optical performance of this single lens will not be determined only by the transfer performance of the outer peripheral area. In other words, there will be no problems, though it depends on cases, as long as the optical performance of the lens as a whole is achieved. In fact, the purpose of restricting the outer periphery which is described in the Japanese Patent Laid-Open No. 2000-1322 is not for improving the transfer performance of the outer peripheral area but for eliminating the centering and edging process.

In contrast, in the present invention, when molding a microlens array having multiple lenses each of which have its own optical performance, the outer periphery of the microlens array is restricted for the purpose of satisfying the requirements that the lenses disposed in the central area and the lenses in the peripheral area should have the same optical performance. That is, it is noted that the present invention differs from those in which a single lens is molded with its outer periphery being restricted.

### SUMMARY OF THE INVENTION

The object of the present invention is to provide a molding method of a microlens array whereby the transfer performances of all of the multiple lens elements of the microlens array, particularly the transfer performances of the lens elements located at the edge of the microlens array are improved, and to provide a molding apparatus of the same.

To achieve the object, the molding method of a microlens array of the present invention, whereby a microlens array is molded by heating and compressing a glass element between oppositely placed first and second cores, comprises the steps of: forming a depression or projection part on the compression molding surface of at least one of the cores for transferring and molding a plurality of convex or concave lens elements; setting a glass element between the compression molding surfaces of the first and second cores; thereafter compressing the glass element between the compression molding surfaces of the first and second cores while providing restriction means for preventing the glass element from escaping in the direction perpendicular to the compression direction of the glass element; and compression molding the glass element with the restriction means and between the compression molding surfaces of the first and second cores.

To achieve this object, the molding apparatus according to the present invention for molding a microlens array by heating and compressing a glass element between oppositely placed first and second cores, is configured such that: a depression or projection part is formed on the compression molding surface of at least one of the first and second cores for transferring and molding a plurality of convex or concave lens elements; a middle plate having a hole at its center is provided, the glass element is set in the hole of the middle plate, and a tip part including the compression molding surface of said at least one of the cores is disposed so as to be able to ascend or descend in the hole of the middle plate; and the glass element is compression molded by means of said compression molding surfaces of the cores and the inner peripheral surface of the hole of the middle plate by moving said compression molding surfaces of both cores in a relatively closing direction.

According to the molding method of the present invention, it is possible to solve a prior art problem that though the transfer performance of the lens elements in the central part is good, the transfer property declines at locations away from the center. Thus, when multiple lines of the lens elements are formed, the lens elements even in an end line have good transfer performances, thus improving the lens performance. In particular, since the outer periphery of the glass element is restricted by the middle plate, an incomplete filling of the glass element into the cavities in the lens molding portion at the location away from the center can be prevented.

According to the molding apparatus of the present invention, not only the lenses molded in the central portion but the lenses molded in a portion far away from the center exerts a good transfer performance, and thus there is no risk of occurrence of transfer failures. In addition, the apparatus itself is simple, and its installation is economical.

### BRIEF DESCRIPTION OF THE DRAWINGS

FIG. 1 is a sectional view of a prior art example;

FIG. 2 is a sectional view of a prior art example in a compressed state;

FIG. 3 is a sectional view of relevant part of the apparatus of the present invention;

FIG. 4 is a sectional view to show a state that the first core is lowered from the state of FIG. 3 to compress the glass element;

FIG. 5 is a plain view of a molded product;

FIG. 6 is a plain view of the middle plate; and

FIG. 7 is an enlarged sectional view of the tip part of the first core.

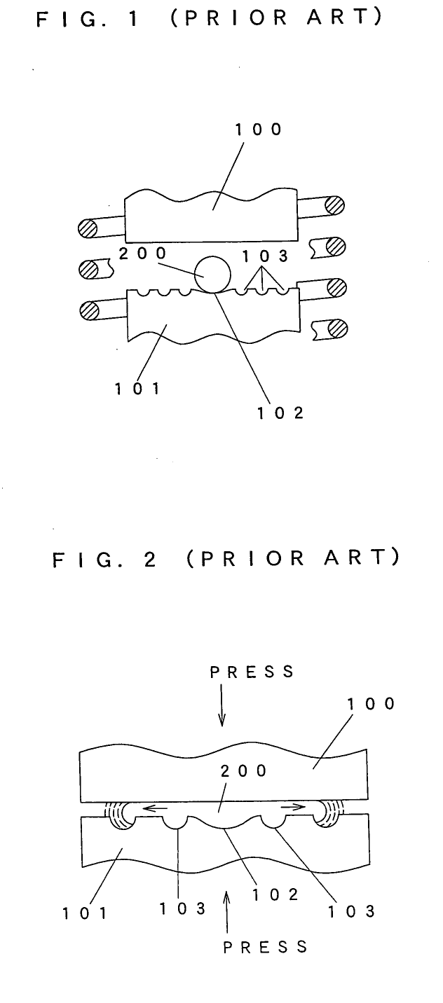

### DETAILED DESCRIPTION OF THE PREFERRED EMBODIMENTS

We now describe in detail the preferred embodiments of the present invention referring to the drawings.

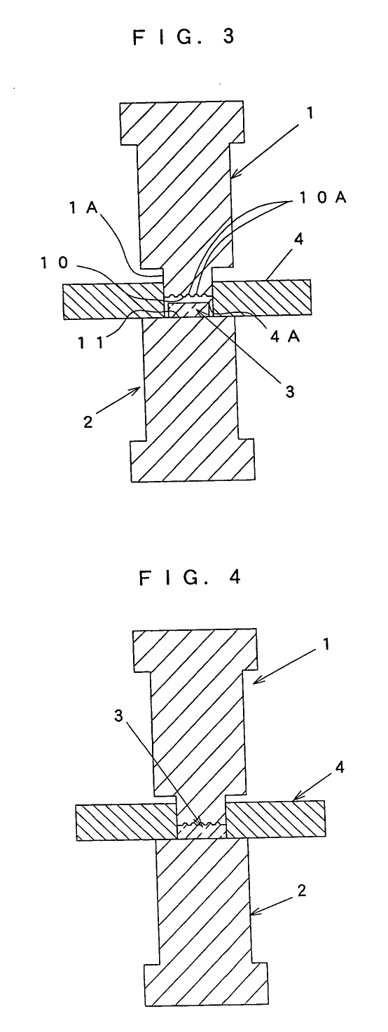

FIG. 3 shows a sectional view of an apparatus for molding a microlens array by compressing a heated glass element 3 between oppositely placed first and second cores 1, 2. In this embodiment, a depression part 10A for molding a plurality of convex lens elements is formed on a compression molding surface 10 of at least one of the cores; that is the core 1 in this embodiment. When setting the glass element 3 between compression molding surfaces 10, 11 of the first and second cores 1, 2, a middle plate 4 formed with a hole 4A at its center is placed on a flattened compression molding surface 11 of the second core. The glass element 3 is set in the hole 4A in such a way that a small amount of gap occurs in the hole 4A of a middle plate 4. Also, the tip part 1A of the first core 1 is configured to be fit into the hole 4A of the middle plate 4 so as to be able to move up and down.

In a state as shown in FIG. 3, the first core 1 is lowered in the hole 4A of the middle plate 4 to compress the glass element 3 with the first and second cores 1, 2. Before the compressing, the glass element 3, the first and second cores 1, 2 and the middle plate 4 are put into a heated condition. Moreover, in a state in which the glass element 3 is heated and compressed, the inside of the cavity is evacuated. When the first core 1 is lowered as shown in FIG. 4 to compress the glass element 3 in cooperation with the second core 2, the glass element 3 is caused to spread in the radial direction, but its further extension in the outward direction will be prevented by the inner peripheral surface of the hole 4A of the middle plate 4. That is, the restriction means which compresses the glass element 3 between the compression molding surfaces 10, 11 of the first and second cores 1, 2, and prevents the escape of the glass element 3 in the direction perpendicular to the compression direction of the glass element 3, i.e., restriction means for restricting the outer diameter are the middle plate 4 and its hole 4A.

A glass element 3 having a melting point of around 320 degrees centigrade, or so called a low-melting point glass element 3 was used. The first core 1 was made of stainless steel, the second core 2 of hard metal material, and the middle plate 4 also of hard metal material. When the glass element 3 having a melting point of around 320 degrees centigrade was used, the heating temperature was set to be 380 degrees centigrade and the applied pressure to be around 70 kgf/cm² at the maximum.

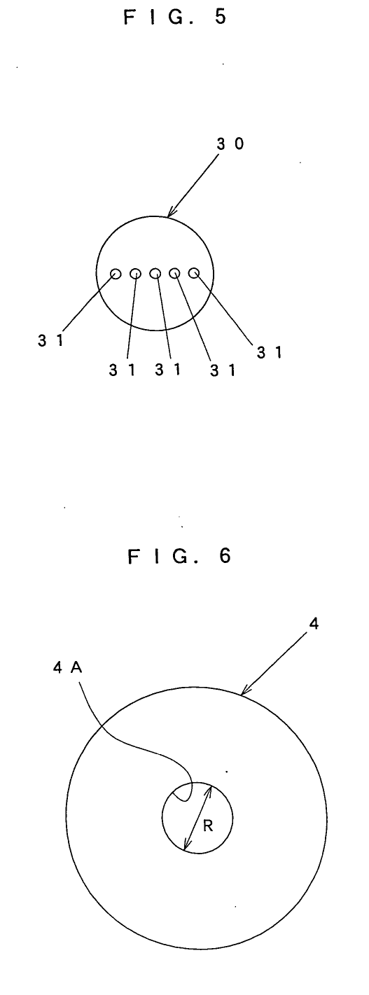

A microlens array 30 molded by the method and the apparatus as described above is shown in FIG. 5. The lens elements 31 of this microlens array 30 are arranged such that 5 elements are aligned horizontally. In this embodiment, the number of the elements is chosen to be 5 by way of explanation, but is not limited to that number. Moreover, the lens elements may be disposed in a radial, concentric, or multiple-line alignment instead of horizontal alignment. A single lens element 31 has a diameter of 250 μm, and the spacing between adjacent lens elements 31 is also 250 μm. Moreover, the diameter of the entire circle is 3.8 mm.

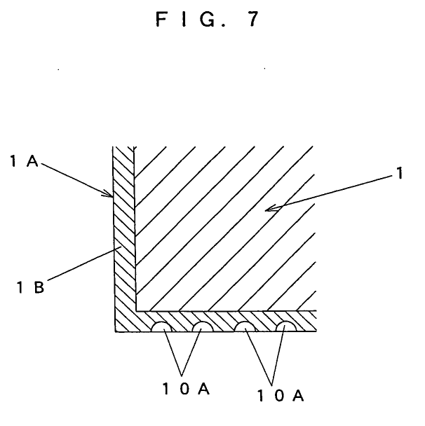

FIG. 6 shows the middle plate 4, of which the hole 4A has a diameter of 3.8 mm. Thus, the diameter of the molded product is also 3.8 mm.

Although the microlens array 30 shown in FIG. 5 has a circular shape, it is also possible to make the microlens array 30 rectangular by forming the hole 4A of the middle plate 4 shown in FIG. 6 to be rectangular. Moreover, in the above described embodiment, a plurality of lens elements 31 are formed only on one side of the microlens array 30, it is also possible to form the lens elements 31 on both sides. Moreover, although the lens element 31 was formed in a convex form, it is also possible to form the lens element 31 in the convex form. Furthermore, in the step of heating and compression, the portion of the glass element 3 was evacuated; however, it is also possible to mold them in a way other than the compression molding in vacuum. Also, the size of the glass element 3, which is placed on the compression molding surface 11 of the second core 2 and set in the hole 4A of the middle plate 4, was configured to be slightly smaller than the hole 4A in the radial direction and be expandable in radial direction. For example, when the diameter of the glass element 3 was not larger than 3.60 mm to 3.75 mm and the hole 4A was 3.8 mm, it was possible to securely transfer the lens elements at locations far away from the center.

After compression molding the lens elements 31 with the means for restricting the outer diameter of the glass element 3, that is the middle plate 4 with the hole 4A, and between each compression molding surface 10, 11 of the first and second cores 1, 2, nitrogen gas is charged into the surrounding part of the first and second cores 1, 2 and the middle plate 4 to cool the molded product. Thereafter the first core 1 is lifted to take out the molded product.

FIG. 7 shows the tip part 1A of the first core 1; there is formed a plating layer 1B in the peripheral surface of the tip part 1A and a depression part 10A is formed by, for example, machining this plating layer 1B. This depression part 10A serves as the transfer surface, on which convex lens elements 31 are molded.

As described so far, for molding a single lens, there is a known method for restricting the outer diameter of the single lens in the prior art. However, since the size of each lens element 31 is very small (diameter of 270 μm) as with case of the present invention, the function of the lens element 31 will be impaired if there is even a slight transfer failure at each part of the lens. Therefore, restriction of the outer diameter is performed as means for improving the transfer performances for all of the multiple small diameter lens elements 31.

What is claimed is:

1. A molding method of a microlens array whereby the microlens array 30 is molded by heating and compressing a glass element 3 between oppositely placed first and second cores 1, 2, comprising the steps of:
forming a depression or projection part 10A on the compression molding surface 10 of at least one of the cores 1 for transferring and molding a plurality of convex or concave lens elements 31;
setting a glass element 3 between the compression molding surfaces 10, 11 of the first and second cores 1, 2; thereafter
compressing the glass element 3 between the compression molding surfaces 10, 11 of the first and second cores 1, 2 while providing restriction means 4 for preventing the glass element 3 from escaping in the direction perpendicular to the compression direction of the glass element 3; and
compression molding the glass element with the restriction means 4 and between the compression molding surfaces 10, 11 of the first and second cores 1, 2.

2. The molding method of a microlens array according to claim 1, wherein the compression molding of the glass element 3 is conducted in vacuum.

3. A molding apparatus of a microlens array, whereby a microlens array 30 is molded by heating and compressing a glass element 3 between oppositely placed first and second cores 1, 2, wherein
a depression or projection part 10A is formed on a compression molding surface 10 of at least one of the first and second cores 1, 2 for transferring and molding a plurality of convex or concave lens elements 31;
a middle plate having a hole 4A at its center is provided;
the glass element 3 is set in the hole 4A of a middle plate 4, and a tip part 1A including the compression molding surface 10 of said at least one of the cores 1 is disposed so as to be able to ascend or descend in the hole 4A of the middle plate 4; and
the glass element 3 is compression molded by means of said compression molding surfaces 10, 11 of the cores 1, 2 and the inner peripheral surface of the hole 4A of the middle plate 4 by moving said compression molding surfaces 10, 11 of both cores 1, 2 in a relatively closing direction.

4. The molding apparatus of a microlens array according to claim 3, wherein a vacuum state is maintained during the compression molding of the glass element 3.
